(19) United States
(12) Patent Application Publication
(10) Pub. No.: US 2010/0196640 A1
(43) Pub. Date: Aug. 5, 2010

(54) HIGH PRESSURE TUBE FOR HYDRAULIC TRANSMISSION

(76) Inventor: Dengfeng Zhang, Shanghai (CN)

Correspondence Address: KILE GOEKJIAN REED & MCMANUS, 1200 NEW HAMPSHIRE AVE, NW, SUITE 570, WASHINGTON, DC, 20036, US

(21) Appl. No.: 12/671,107

(22) PCT Filed: Sep. 28, 2008
(86) PCT No.: PCT/CN08/01674

§ 371 Date: Jan. 28, 2010

(30) Foreign Application Priority Data
Oct. 12, 2007 (CN) 200710046969.2

(51) Int. Cl. B32B 25/20; B32B 1/08; B32B 25/08; B32B 5/02

(52) U.S. Cl. 428/36.2

(57) ABSTRACT

This invention relates a high pressure tube for hydraulic transmission consisting of the silicon rubber tube, the knitted fiber layer and the protective layer, the knitted fiber layer is fixed between the silicon rubber tube and the protective layer, which is characterized in that the material of the said silicon rubber tube is silicon rubber material KE581U; the said knitted layer is made by the knitting of terylene wire; the material of the said protective layer is silicon resin KR-166. The advantages summed up for this invention are in features of anti-ageing, anti-corrosion, withstanding high temperature, pliability, low shrinking ratio and environmental friendly, the said tube can be used for hydraulic transmission system in cases of very high pressure, the minimum explosive pressure reaches 15.5 MPa and the pressure under normal operation is 10 MPa at temperature of 20° C.,

### TECHNICAL FIELD

This invention relates to a high pressure tube for hydraulic transmission, which can be used as tube for hydraulic transmission equipped in special equipment and instrumentation such as medical instrument, electric appliance, aviation and spaceflight utilization, automobile etc. it belongs to the technical aspect of tube for hydraulic transmission.

### TECHNICAL BACKGROUND

The high pressure tube for hydraulic transmission equipped in special equipment and instrumentation such as medical instrument, electric appliance, aviation and spaceflight utilization, automobile etc, consists of the silicon rubber tube, the knitted layer and the protective layer. A common fiber layer is fixed outside the silicon rubber tube and a silicon rubber wrapped around the fiber layer, the protective layer of the said silicon rubber tube is of common silicon rubber material, the said knitted layer is made of knitted glass fiber, the shortage is that the minimum explosive pressure thereof can't be higher than 5 MPa at temperature of 20° C.

### INVENTION CONTENT

This invention is aimed at providing a high pressure tube for hydraulic transmission with features of anti-ageing, anti-corrosion, withstanding high temperature, pliability, low shrinking ratio and environmental friendly, as well as withstanding pressure of 10 MPa.

To fulfill above-mentioned purpose the technical scheme of this invention is to provide a high pressure tube for hydraulic transmission consisting of the silicon rubber tube, the knitted fiber layer and the protective layer, the knitted fiber layer is fixed between the silicon rubber tube and the protective layer, which is characterized in that the material of the said silicon rubber tube is silicon rubber material KE581U; the said knitted layer is made by the knitting of terylene wire; the material of the said protective layer is silicon resin KR-166.

It is selected in this invention that the enforced knitted skeleton is made of a particular high strength fiber material, which outside is covered by the liquid resin causing the features of silicon rubber with anti-ageing, anti-corrosion, withstanding high temperature, pliability and low shrinking ratio, forming a seamless combination with this special fiber of high strength, additionally, it is anchored and protected by covered liquid resin, and results in the sufficient developed property of the product as well as possess the ability of withstanding ultra high pressure, besides, the tube is not thicker than that of the regular product, thus it can substitute the tabernacle of metal or PVC without the property of pliability and the tube made of rubber without the property of anti-aging and withstanding high temperature in some cases.

The advantages summed up for this invention are in features of anti-ageing, anti-corrosion, withstanding high temperature, pliability, low shrinking ratio and environmental friendly, the said tube can be used for hydraulic transmission system in cases of very high pressure, the minimum explosive pressure reaches 15.5 MPa and the pressure under normal operation is 10 MPa at temperature of 20° C.

### DESCRIPTION OF SKETCHES

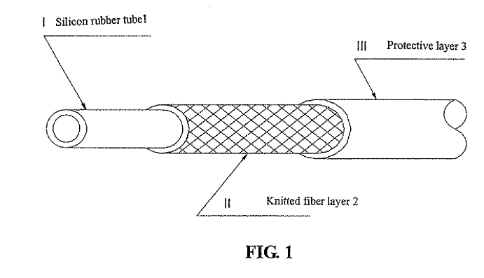

FIG. 1 The sketch showing structure of a high pressure hydraulic transmission tube.

### MANNER OF UNDERTAKING

A preferred embodiment of the invention is illustrated in the accompanying drawing in which:

Example of Undertaking:
As shown in FIG. 1, it is the sketch showing structure of a high pressure tube for hydraulic transmission, the said high pressure tube for hydraulic transmission consists of the silicon rubber tube 1, the knitted layer 2 and the protective layer 3, the knitted fiber layer 2 is fixed between the silicon rubber tube 1 and the protective layer 3, the material of the said silicon rubber tube is the purchased silicon rubber material KE581U , with the thickness is 3 mm, the material of the said knitted fiber layer 2 is terylene wire, with the thickness of 0.4 mm, the material of the said protective layer is the purchased silicon resin KR-166, with the thickness of 0.025 mm.

The fabrication technology is described as follows:

To select silicon rubber material KE581U as a solid silicon rubber which is put into the mixing rolls for mixing, the duration of mixture is 12-25 min, and squeezed out as the common silicon rubber tube in a squeezing machine at temperature of 180° C.-250° C., with the squeezing speed of 3-5 m/min, then the terylene wire has been knitted on the common silicon rubber tube by the braiding machine, the speed of knitting is about 20 m/hr, eventually, the liquid resin KR-166 is covered on the surface thereof by means of coating, the coating temperature is 200° C.-260° C., with the speed of 40-60m/hr, consequently the isolation bushing tube is fabricated completely.

What we claim is:

1. A high pressure tube for hydraulic transmission consists of the silicon rubber tube (1), the knitted fiber layer (2) and the protective layer (3), the knitted fiber layer (2) is fixed between the silicon rubber tube (1) and the protective layer (3), which is characterized in that the material of the said silicon rubber tube (1) is silicon rubber material KE581U; the said knitted layer (2) is made by the knitting of terylene wire; the material of the said protective layer (3) is silicon resin KR-166.

2. The high pressure tube for hydraulic transmission according to the claim 1, wherein the said high pressure tube for hydraulic transmission is characterized in that the thickness of the said silicon rubber tube (1) is 1.5 mm-5 mm.

3. The high pressure tube for hydraulic transmission according to the claim 1, wherein the said high pressure tube for hydraulic transmission tube is characterized in that the thickness of the said knitted layer is 0.3 mm-0.6 mm.

4. The high pressure tube for hydraulic transmission according to the claim 1 wherein the said high pressure tube for hydraulic transmission is characterized in that the thickness of the said protective layer is 0.001 mm-0.05 mm.
